(19) United States
(12) Patent Application Publication
(10) Pub. No.: US 2011/0318237 A1
(43) Pub. Date: Dec. 29, 2011

(54) ULTRAVIOLET REACTOR BAFFLE DESIGN FOR ADVANCED OXIDATION PROCESS AND ULTRAVIOLET DISINFECTION

(76) Inventors: Richard Woodling, Singapore (SG); Jing Feng, Singapore (SG); Davis Yohanes Arifin, Singapore (SG); Kok Wee Henry Lim, Singapore (SG)

(21) Appl. No.: 12/824,157

(22) Filed: Jun. 26, 2010

(51) Int. Cl. B01J 19/08

(52) U.S. Cl. 422/186.3

(57) ABSTRACT

Ultraviolet reactors having an ultraviolet light source for treating a fluid are disclosed. In one embodiment, a reactor is disclosed which includes a vessel having an inlet for receiving fluid and an outlet for discharging fluid. The vessel further includes a plurality of segmented baffles. The baffles further include a partial circumferential edge section that terminates in a vertical edge section to form right and left segmented baffles. The left and right segmented baffles are arranged in an alternating pattern in the vessel to provide plug flow and enhanced radial mixing.

### FIELD OF THE INVENTION

This invention relates to ultraviolet reactors, and more particularly, to baffle configurations for ultraviolet reactors.

### BACKGROUND OF THE INVENTION

Ultraviolet light (UV) light is an effective means for pollutant removal from contaminated waters through either direct UV photolysis or UV radiation-indirectly-induced oxidation of chemical compounds. UV light has also been proven to be effective for water and wastewater disinfection. The efficiency with which a UV reactor is able to degrade the contaminant or inactivate the microorganisms is dependent on several parameters including the hydraulic characteristics of the reactor, the spatial UV fluence rate distribution within the reactor and the degradation or inactivation kinetics of the target compounds or species. The UV fluence rate is attenuated by the distance from the lamp and the transmittance of the media. Generally, the higher the UV fluence rate, the faster the activation of oxidant.

Developing a suitable flow pattern is an important consideration for increasing the efficiency of a UV reactor. It is desirable that the flow pattern result in sufficient radial mixing with a uniform residence time so that the water receives a relatively uniform UV dosage. Turbulent flow is typically used to achieve sufficient radial mixing. However, such flow is achieved by using a relatively high flow rate, which undesirably results in a relatively short residence time. In order to achieve uniform residence time, plug flow is desired. However, this results in relatively poor mixing especially for fluid particles flowing in regions relatively far from the UV lamp, such as near the wall of the UV reactor.

### SUMMARY OF THE INVENTION

Ultraviolet reactors having an ultraviolet light source for treating a fluid are disclosed. In one embodiment, a reactor is disclosed which includes a vessel having an inlet for receiving fluid and an outlet for discharging fluid. The vessel further includes a plurality of segmented baffles. The baffles further include a partial circumferential edge section that terminates in a vertical edge section to form right and left segmented baffles. The left and right segmented baffles are arranged in an alternating pattern in the vessel to provide plug flow and enhanced radial mixing.

### BRIEF DESCRIPTION OF THE DRAWINGS

FIG. 1 depicts an embodiment of a UV reactor which includes helical baffles.

FIG. 2 is an E-curve depicting the hydraulic retention time for a UV reactor with and without helical baffles.

FIG. 3 depicts water mass fraction versus UV dosage for a UV reactor with and without helical baffles.

FIGS. 4a-4c depict the fluence rate distribution for a UV reactor without a baffle, with a full helical baffle and with a helical baffle having an 80% width, respectively.

FIGS. 5a-5e depict a particle flow path for a UV reactor without a helical baffle and for a UV reactor having helical baffles of varying widths.

FIG. 6 shows the experimental results of persulfate dissociation in a UV batch reactor with and without a coating.

FIG. 7 shows the results of an experiment regarding urea oxidation in a UV batch reactor with and without a coating.

FIG. 8 depicts an alternate embodiment of a UV reactor which includes segmented baffles.

FIG. 9 is a perspective view of a left segmented baffle.

FIG. 10 depicts rods for supporting the segmented baffles.

FIG. 11 is an E-curve depicting the hydraulic retention time of a UV reactor with and without segmented baffles.

FIG. 12 depicts water mass fraction versus UV dosage for a UV reactor with and without segmented baffles.

FIG. 13 is an E curve depicting a comparison between helical and segmented baffle configurations with respect to residence time distribution.

FIG. 14 depicts a comparison between helical and segmented baffle configurations with respect to incidence radiation.

FIG. 15 depicts a comparison between helical and segmented baffle configurations with respect to particle flow path lines.

### DESCRIPTION OF THE INVENTION

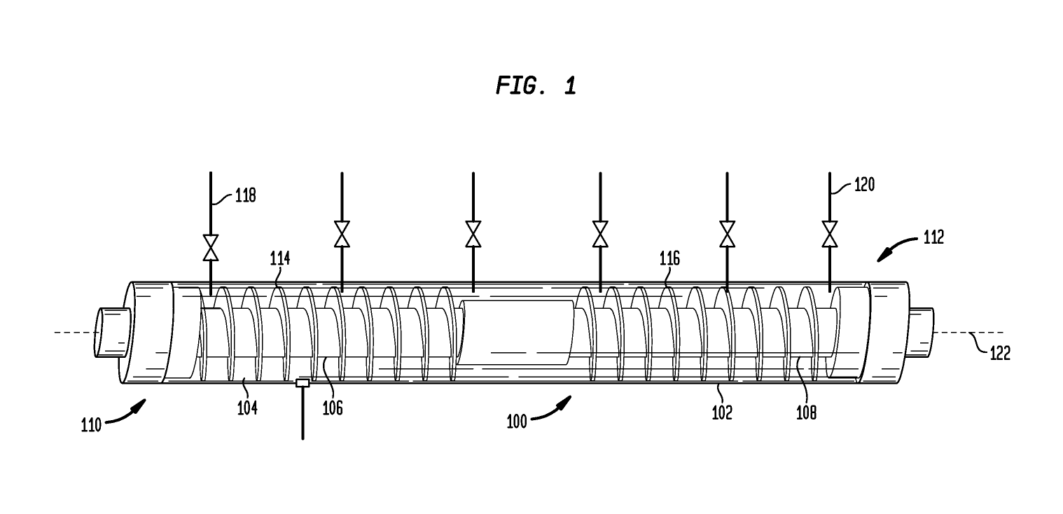

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass direct and indirect mountings, connections, supports, and couplings. Further, “connected” and “coupled” are not restricted to physical or mechanical connections or couplings. In the description below, like reference numerals and labels are used to describe the same, similar or corresponding parts in the several views of FIGS. 1-15.

Referring to FIG. 1, an embodiment of an ultraviolet (UV) reactor 100 in accordance with the present invention is shown as a partial cross sectional view. The reactor 100 includes a cylindrically shaped vessel 102 having first 110 and second 112 ends and an interior chamber 104. The vessel 102 may be fabricated from stainless steel and may be used for an advanced oxidation process or a UV disinfection process. The size and diameter of the vessel 102 is related to the characteristics of the target water, UV lamp diameter and output wavelength of the UV lamp.

In order to increase input UV energy, a pair of UV lamps may be utilized although it is understood that other configurations may be used. In the current embodiment, the UV reactor 100 includes first 106 and second 108 UV lamps which extend from first 110 and second 112 ends, respectively, of the vessel 102 into the chamber 104.

The UV reactor 100 further includes spiral or helically shaped first 114 and second 116 baffles which extend around the first 106 and second 108 UV lamps, respectively. In a preferred embodiment, the first 114 and second 116 baffles each include 10 coils or layers. The first 114 and second 116 baffles serve to guide or channel fluid in a helical flow path which corresponds to the shape of the respective baffles 114,116 as fluid flows from the first end 110 to the second end 112 of the vessel 102. The first 114 and second 116 baffles may be fabricated from stainless steel or quartz.

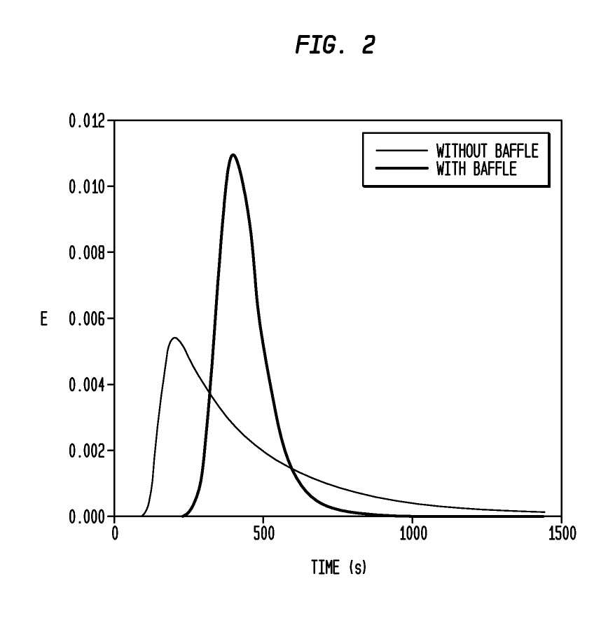

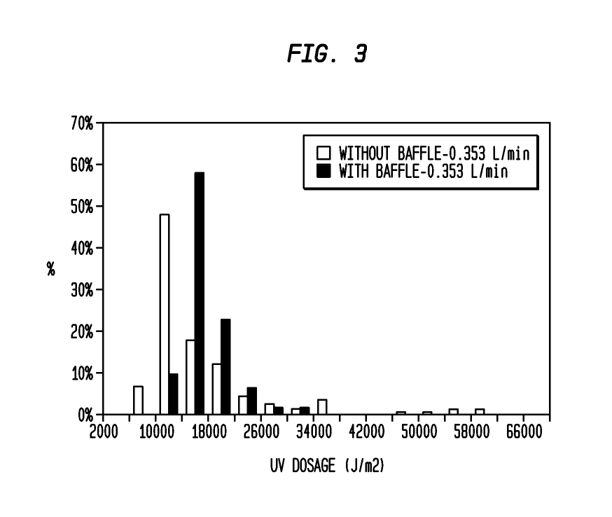

The first 114 and second 116 baffles increase hydraulic retention time and provide enhanced radial mixing. FIG. 2 is an E-curve depicting an analysis of residence time distribution wherein E is a measure of exit-normalized concentration versus time from a pulse input tracer of concentration equal to 1. Referring to FIG. 2, it has been found that use of the first 114 and second 116 baffles increases the hydraulic retention time of the fluid within the UV reactor 100 as compared to a reactor without helical baffles. FIG. 3 is a graph depicting the water mass fraction, as a percentage, which receives a certain UV dosage during its residence time in the reactor plotted against UV dosage. Referring to FIG. 3, tests have also shown that use of a helical baffle results in enhanced radial mixing of the fluid within the vessel 102 and thus enhanced UV dose distribution as compared to a reactor without a helical baffle. In addition, the number of dead zones or short circuit flow paths inside the reactor are substantially reduced or eliminated. As such, use of the first 114 and second 116 baffles provides plug flow with a relatively high degree of radial mixing.

The UV reactor 100 also includes inlet 118 and outlet 120 ports for receiving and discharging fluid, respectively. The inlet 118 and outlet 120 ports are positioned substantially perpendicular to a longitudinal axis 122 of the vessel 102 and are aligned to cooperate with the first 114 and second 116 baffles.

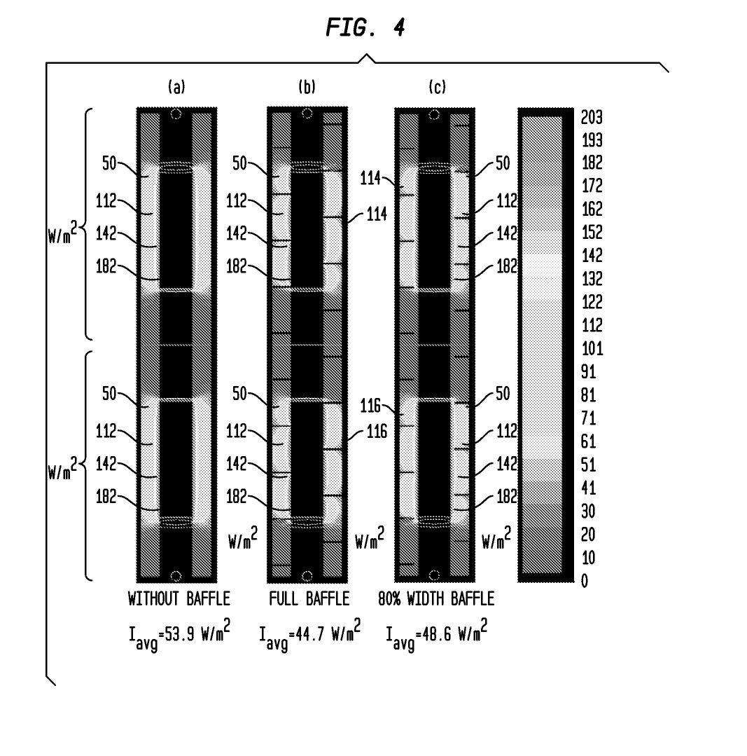

It has been found that the presence of a baffle fabricated from stainless steel inside the reactor 100 blocks a portion of the UV light emitted by the UV lamps. FIGS. 4a-4c depict the fluence rate distribution for a UV reactor that does not include a baffle, a UV reactor that includes a full width, 10 layer helical stainless steel baffle and a UV reactor that includes a 10 layer helical stainless steel baffle whose width is approximately 80% of a gap between a wall of the vessel and a surface of a UV lamp, respectively. Calculations show that the average UV light intensity decreases by approximately 19% when a 10 layer helical stainless steel baffle is used. If a width of a baffle is decreased to approximately 80% of a gap between a wall of the vessel and a surface of a UV lamp, the energy that is lost is decreased by approximately 10%. In accordance with the present invention, a desired fluence rate distribution may thus be achieved by selecting an appropriate size baffle.

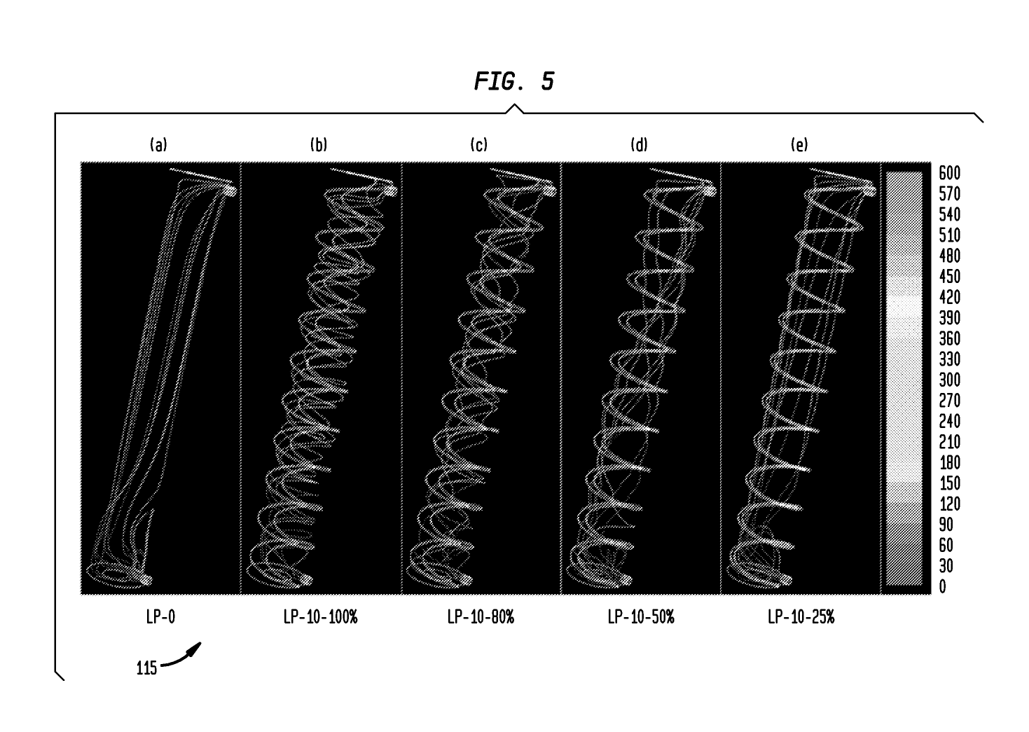

FIG. 5a depicts a particle flow path 115 for a UV reactor that does not include a baffle. FIGS. 5b-5e depict the particle flow path 115 for a 10 layer stainless steel helical baffle whose width is 100%, 80%, 50% and 25%, respectively, of a gap between a wall of the vessel and a surface of a UV lamp (LP denotes low pressure lamp). As shown in FIGS. 5b-5e, the effect of the helical baffle with respect to radial mixing decreases as the width of the baffle decreases. In particular, if the width of the helical baffle is less than 50% of the gap between a wall of the vessel and a surface of a UV lamp, the effect of the helical baffle with respect to radial mixing is negligible. On the other hand, although a wider helical baffle can achieve better radial mixing inside the reactor, the helical baffle can also block part of the UV light, which leads to a relatively weaker fluence rate.

Calculations show that the average UV irradiance for a 10 layer, 100% width baffle reactor is approximately 80% of that in a reactor without baffle. In order to decrease the amount of UV energy loss due to the baffle, either a UV reflective or a photo catalytic coating layer may be applied to the stainless steel surface of the baffle. In regard to a baffle having photo catalytic coating, it has been shown that silver ion effectively activates the persulfate ion to generate a sulfate radical. Another coating which may be used to decrease the effect of UV energy loss is a titania coating having a mesoporous nano-structure which can effectively adsorb organics. Further, the band gap of nano-structure titania may be adjusted to absorb the corresponding UV wavelength output for the UV lamp that is being utilized. An atom of a persulfate catalyst (e.g. Ag, etc.) can be immersed into the titania crystal structure to enhance the catalytic effects.

A UV reactor is typically fabricated from stainless steel. In order to enhance UV reflectivity, the interior stainless steel wall of the UV reactor is typically polished. The reflectivity for a polished stainless steel surface is in the range of 30% to 50%. Thus, 50% or more of UV light which falls on the reactor wall is either absorbed by the reactor or converted into heat. In order to enhance reflectivity, a microporous diffuse type reflector may be used to coat the interior wall of the UV reactor. A suitable reflector may be fabricated from GORE™ DRP® Diffuse Reflector Material type light diffusing material, for example. This material is fabricated from highly stable, chemically inert polytetrafluoroethylene (PTFE) and provides the added benefit that no secondary contamination will leach out from the reflector. The reflectivity of a reflector is related to the thickness of the material and wavelength of the UV light that is used. By way of example, a 1 mm thick reflector has a reflectivity of greater than 99.5% at a UV wavelength of 254 nm. In the presence of a UV reflector, the UV light undergoes multiple reflections within the UV reactor and leads to a greater UV intensity and a more homogeneous UV field compared to a system without a reflector.

Experiments regarding the effect of a UV reflector were performed with a UV batch reactor that is used for high purity water treatment. The light path of the UV batch reactor was 4 cm. The average intensity in the UV batch reactor without reflector was simulated to be 31.2 W/m². Persulfate was used as an oxidant precursor. The transmittance of persulfate solution at a UV wavelength of 254 nm was determined to be 99.3%, which indicates that 97% of UV energy will impinge on the wall of UV reactor.

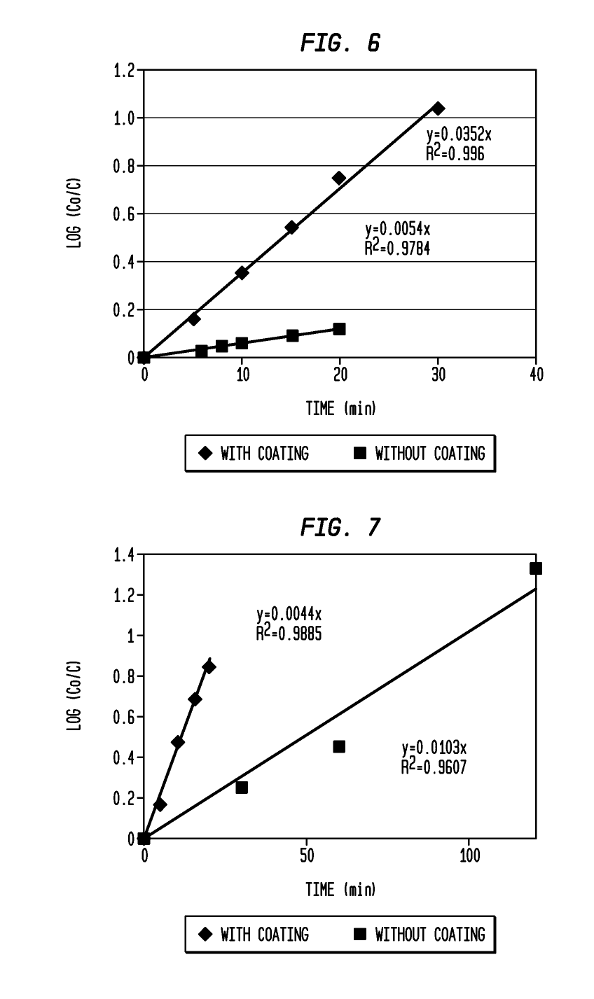

FIG. 6 shows the experimental results of persulfate dissociation in the UV batch reactor with and without a coating. It was determined that the dissociation rate of persulfate in a UV system with a reflector was approximately 6.5 times higher than that without a reflector. The average UV intensity was simulated with the dissociation rate of persulfate and was determined to be approximately 7.5 times higher than that in a UV reactor without a coating. Referring to FIG. 7, the results of an experiment regarding urea oxidation in the UV batch reactor with and without a coating is shown. It is noted that the UV wavelength was 254 nm, the initial urea concentration was 1 mgTOC/I and persulfate concentration was 0.26 mM. As a result, it was determined that the degradation rate constant of urea was approximately 4.4 times higher due to the reflector.

A UV reflector is suitable for use in several applications including high purity water treatment wherein the transmittance is usually higher than 99% which thus leads to an increased amount of energy reaching the wall of the reactor. In addition, a shorter light path maximizes the efficiency of a reflector. In accordance with the present invention, fewer UV lamps may be needed in a reactor to achieve an equivalent UV intensity if a UV reflector is used. Therefore, the capital cost for a UV chamber and operational costs for items such as energy consumption and UV lamp replacement are significantly decreased.

In another embodiment, the current invention is directed to a UV reactor having a segmented baffle configuration. This configuration also provides enhanced radial mixing and relatively uniform UV dosage as previously described. In addition, the segmented baffle configuration may be fabricated using straightforward manufacturing techniques and may be readily scaled up depending on the application.

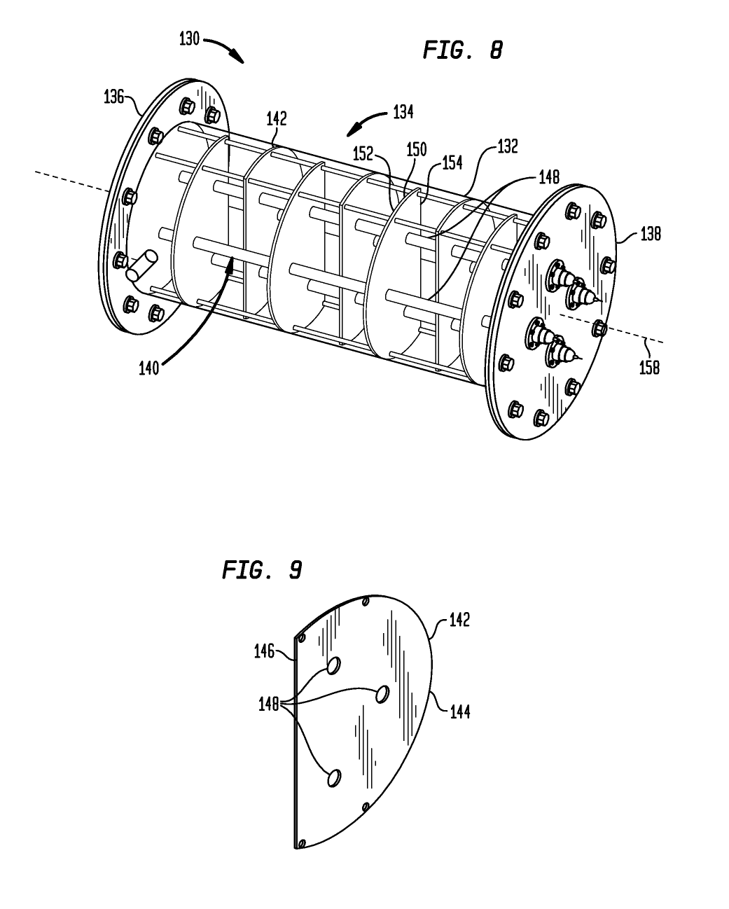

Referring to FIG. 8, a UV reactor 130 in accordance with the present embodiment is shown. The UV reactor 130 includes a cylindrical vessel 132 having a plurality of spaced apart segmented baffles 134 located between first 136 and second 138 end plates. UV lamps 140 extend between the first 136 and second 138 end plates and through the segmented baffles 134. In one configuration, four low pressure UV lamps 140 are used and the UV reactor 130 includes seven segmented baffles 134 which are spaced apart at 127 mm intervals from each other. Each of the segmented baffles 134 has a diameter of approximately 400 mm and a thickness of approximately 2 mm. Each of the segmented baffles 134 also includes a 1 mm reflector coating. It is understood that a greater or lesser number of baffles 134 may be used, that the baffles may vary in size and that different spacing between the baffles 134 may be used.

The segmented baffles 134 may be either left 142 or right 150 segmented baffles. Referring to FIG. 9 in conjunction with FIG. 8, a perspective view of a left segmented baffle 142 is shown. The left segmented baffle 142 has a substantially reverse C-shaped configuration which includes a partial circumferential edge section 144 that terminates in a left vertical edge section 146 located on the left side of the baffle 142. The left segmented baffle 142 further includes through holes 148 for receiving the UV lamps 134.

The right segmented baffle 150 has a reverse configuration to that of the left segmented baffle 142. In particular, each right segment baffle 150 has a substantially C-shaped configuration which includes a partial circumferential edge section 152 that terminates in a right vertical edge section 154 located on the right side of the baffle 150. Each right segmented baffle 150 also includes through holes 148 for receiving the UV lamps 134. Although the left 142 and right 150 segmented baffles are shown with a left 146 and right 154 vertical edge sections, respectively, it is understood that the edge sections 146,154 may be oriented horizontally or angled between vertical and horizontal in accordance with the present invention. In addition, the left 142 and right 150 segmented baffles may also include a reflector coating as previously described to reduce the effects of any UV light blocking by the segmented baffles 142,150.

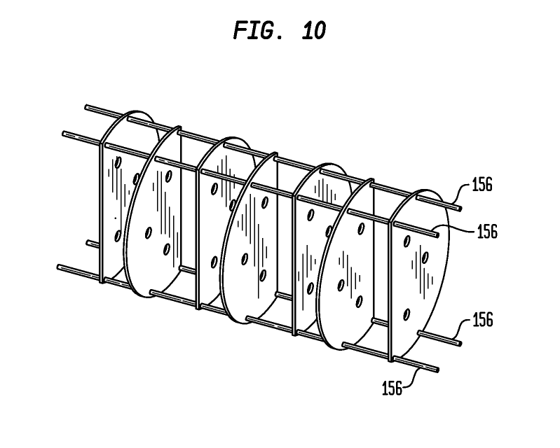

Referring to FIG. 10 in conjunction with FIG. 8, the left 142 and right 150 segmented baffles are supported by rods 156 which extend between the first 136 and second 138 end plates. The left 142 and right 150 segmented baffles are installed alternately in a left-right segmented baffle pattern along a longitudinal axis 158 of the UV reactor 130 to enable flow along the UV lamps 140 although other configurations may be used. In accordance with the present invention, the left 142 and right 150 segmented baffles provide plug flow. Further, the number of dead zones or short circuit flow paths inside the reactor are substantially reduced or eliminated. In addition, the incidence radiation distribution is comparable with that of a helical baffle.

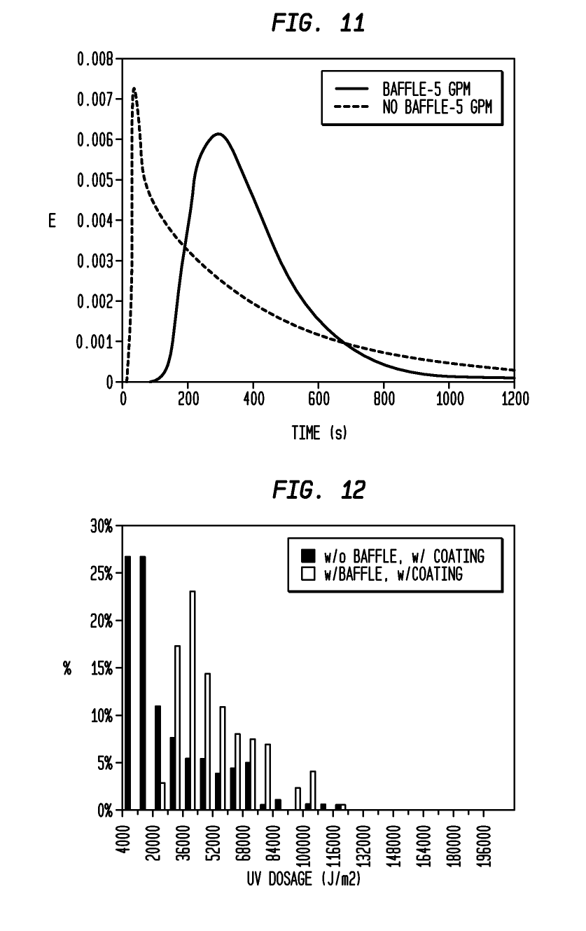

Referring to FIG. 11, it has been found that use of segmented baffles 134 increases the hydraulic retention time of the fluid within the UV reactor 130 as compared to a reactor without segmented baffles. Referring to FIG. 12, tests have also shown that use of segmented baffles 134 with a reflector coating results in enhanced radial mixing of the fluid within the vessel and thus enhanced UV dose distribution as compared to a reactor with a reflector coating and without segmented baffles.

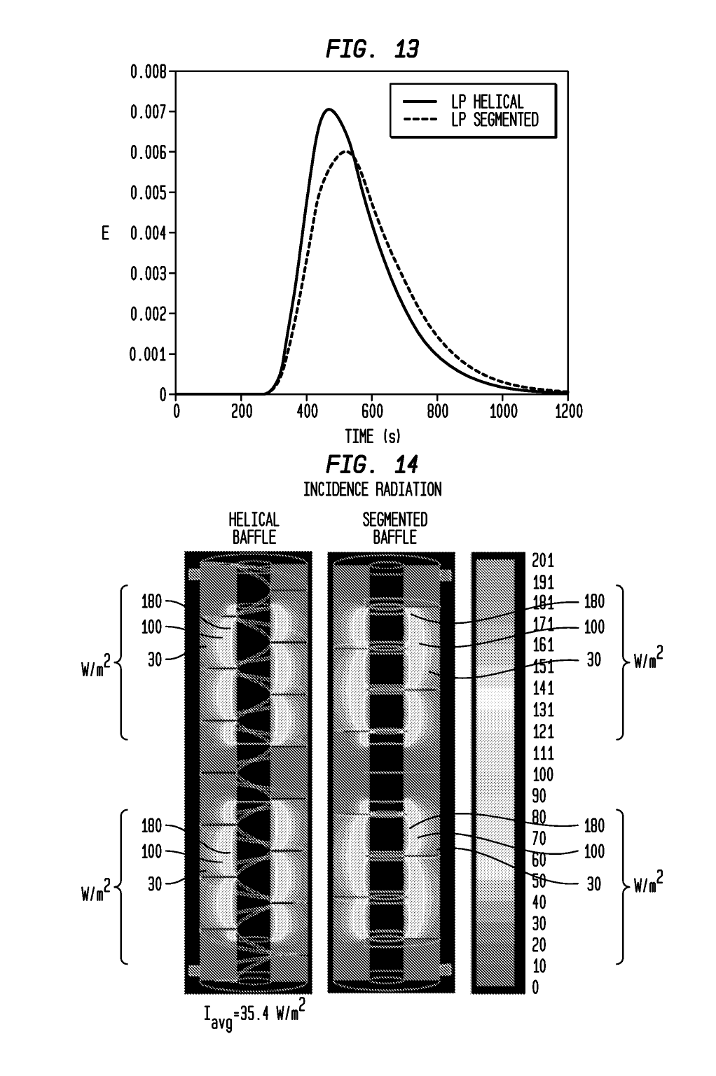

FIG. 13 depicts a comparison between helical and segmented baffle configurations with respect to residence time distribution. As can be seen, the residence time distribution of the segmented baffle configuration is similar to that of the helical baffle configuration. The residence time distribution peaks indicate that the residence time of the flow is uniform which also indicates that substantially all fluid particles will receive a similar UV dosage.

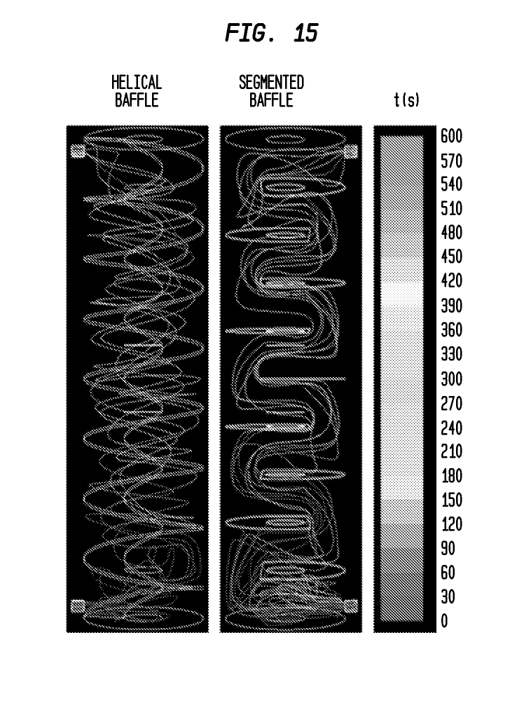

FIG. 14 depicts incidence radiation for the helical and segmented baffle configurations. As can be seen, the intensity between the baffle configurations is substantially similar. FIG. 15 depicts a comparison between the helical and segmented baffle configurations with respect to particle flow path lines. The path lines indicate plug flow along with a sufficiently high degree of mixing for both the helical and segmented baffle configurations.

While the invention has been described in conjunction with specific embodiments, it is evident that many alternatives, modifications, permutations and variations will become apparent to those skilled in the art in light of the foregoing description. Accordingly, it is intended that the present invention embrace all such alternatives, modifications and variations.

What is claimed is:

1. A reactor for treating a fluid, comprising:
a vessel having an inlet for receiving fluid and an outlet for discharging fluid;
an ultraviolet light source located within said vessel; and
a baffle having a helical shape, wherein said baffle extends around said ultraviolet light source and guides said fluid from said inlet to said outlet to provide radial mixing of said fluid.

2. The reactor according to claim 1 wherein said baffle includes 10 layers.

3. The reactor according to claim 1 wherein a width of said baffle is approximately 80% of a gap between an interior wall of said vessel and a surface of said ultraviolet light source.

4. The reactor according to claim 1 wherein said baffle includes a photo catalytic coating for decreasing an amount of ultraviolet energy loss due to said baffle.

5. The reactor according to claim 1 wherein said baffle includes a reflective layer in order to enhance reflectivity within said vessel.

6. The reactor according to claim 5 wherein said reflector is fabricated from polytetrafluoroethylene.

7. The reactor according to claim 1 further including an additional ultraviolet light source located within said vessel.

8. The reactor according to claim 7 further including a baffle having a helical shape which extends around said additional ultraviolet light source.

9. The reactor according to claim 1 wherein said inlet and outlet are oriented substantially perpendicular to a longitudinal axis of said vessel and aligned for cooperating with said helical baffle.

10. A reactor for treating a fluid, comprising:
a vessel having an inlet for receiving fluid and an outlet for discharging fluid;
an ultraviolet light source located within said vessel; and
a plurality of segmented baffles located within said vessel, wherein said baffles include a partial circumferential edge section that terminates in a vertical edge section.

11. The reactor according to claim 10 wherein said segmented baffles include a plurality of left segmented baffles having a substantially reverse C-shaped configuration that terminates in a left vertical edge.

12. The reactor according to claim 10 wherein said segmented baffles include a plurality of right segmented baffles having a substantially C-shaped configuration that terminates in a right vertical edge.

13. The reactor according to claim 10 wherein said segmented baffles include alternating right and left segmented baffles.

14. The reactor according to claim 10 wherein said segmented baffles include a reflective coating having a thickness of approximately 1 mm.

15. The reactor according to claim 10 which includes seven segmented baffles.

16. The reactor according to claim 10 wherein said segmented baffles are approximately 2 mm thick.

17. The reactor according to claim 10 wherein said segmented baffles have a diameter of approximately 400 mm.

18. The reactor according to claim 10 wherein said segmented baffles are spaced approximately 127 mm apart from each other.

19. The reactor according to claim 10 which includes four ultraviolet light sources.

20. The reactor according to claim 10 wherein said segmented baffles are supported by rods.
